(19) United States
(12) Patent Application Publication
(10) Pub. No.: US 2013/0282808 A1
(43) Pub. Date: Oct. 24, 2013

(54) System and Method for Generating Contextual User-Profile Images

(71) Applicants: Suhas Sadanandan, Sunnyvale, CA (US); Sudharsan Vasudevan, Sunnyvale, CA (US); Hemanth Sambrani, Bangalore (IN)

(72) Inventors: Suhas Sadanandan, Sunnyvale, CA (US); Sudharsan Vasudevan, Sunnyvale, CA (US); Hemanth Sambrani, Bangalore (IN)

(73) Assignee: YAHOO! INC., Sunnyvale, CA (US)

(21) Appl. No.: 13/452,808

(22) Filed: Apr. 20, 2012

(51) Int. Cl. G06F 15/16

(52) U.S. Cl. 709/204

(57) ABSTRACT

Methods and systems for generating contextual user-profile image on a webpage include capturing textual content provided by a user at the webpage. The textual content is parsed to identify keywords related to context. The keywords are contextually analyzed to identify one or more mood indicators. Current mood of the user is identified based on the one or more mood indicators. One or more modifiers for applying to the user-profile image are determined. The user-profile image is updated to incorporate the modifiers so as to reflect the current mood of the user. The updated user-profile image is returned to the webpage for rendering, in response to the textual content received from the user.

### BACKGROUND

1. Field of the Invention

The invention relates generally to providing a user-profile image of a user at a webpage and, more particularly, to providing a personalized user-profile image that changes according to context, content and mood of the user as reflected in the webpage.

2. Description of the Related Art

An avatar is an Internet user's representation of the user commonly in the form of a two-dimensional icon that can be used in Internet forums and other virtual communities. For example, today Internet user's can use avatars to communicate their activities, location, or mood to other users. However, these avatars or user-profile images on various webpages and blogs are generally static. In order for the avatars to communicate the users various characteristics, such as mood, location, activity, etc., users must update their avatar to display their current activity, location, or mood, each time there is a change in the user's context.

In view of the forgoing, there is a need to automatically update an avatar based on user context in a manner that guarantees that a user's avatar is an accurate representation of the user's current state of mind or user's contextual interest.

### SUMMARY

Embodiments of the disclosure provide methods and system define a mechanism that is used for generating contextual user-profile images for a user on a webpage. In some embodiments, the user-profile images are dynamically generated and automatically changed to reflect a user's current mood or contextual interest based on context and content provided in the webpage by the user. In other embodiments, changes to user-profile images may be identified and implemented only upon obtaining permission from the relevant user(s). The changing of user-profile images is implementation-specific. The mood change mechanism can be incorporated in more than one webpage that a user uses for social interaction and allow synchronization of the user-profile image amongst the different webpages. It should be appreciated that the present embodiments can be implemented in numerous ways, such as a process, an apparatus, a system, a device, or a method on a computer readable medium. Several embodiments are described below.

In one embodiment, the present invention provides a method for generating contextual user-profile image on a webpage. The method includes capturing textual content provided by a user at the webpage. The textual content is parsed to identify keywords related to context. The keywords are contextually analyzed to identify one or more mood indicators. Current mood or contextual interest of the user is identified based on the one or more mood indicators. One or more modifiers for applying to the user-profile image are determined. The user-profile image is updated to incorporate the modifiers so as to reflect the current mood or contextual interest of the user. The updated user-profile image is returned to the webpage for rendering, in response to the textual content received from the user.

In another embodiment, a method for generating contextual user-profile image on a webpage is provided. The method includes obtaining user identifier of a user accessing the webpage. It is then determined if the user-profile image exists for the user associated with the user identifier. If the user-profile image does not exist for the user, then user profile data defining user attributes provided by the user is identified. A user-profile image for the user is generated from a default image using the user attributes defined in the user profile data. The generated user-profile image is dynamically modified to reflect a current mood or contextual interest of the user based on analysis of textual content provided by the user at the webpage. The modified user-profile image is returned to the webpage for rendering, in response to the textual content received from the user.

In yet another embodiment, a system for generating contextual user-profile image on a webpage is disclosed. The system includes a server device and a client device each coupled to the Internet. The server is equipped with a server-side application programming interface code (API) for generating the contextual user-profile image on the webpage. The server-side API is configured to receive an API call from the webpage. The API call includes one or more call parameters and is made requesting an updated user-profile image of a user. In response to the API call, the server-side API generates the updated user-profile image based on content provided by a user at the webpage. The generation of the user-profile image by the server-side API includes downloading the content provided by the user from the webpage; extracting the keywords from the downloaded content; identifying one or more mood indicators by performing contextual analysis of the extracted keywords; determining current mood or contextual interest of the user based on the one or more mood indicators; identifying modifiers for applying to the user-profile image for the current mood or contextual interest; and updating the user-profile image of the user by incorporating the identified modifiers to the user-profile image. The updated user-profile image reflecting the current mood or contextual interest of the user. The client device is used to request and render the webpage, wherein the webpage includes a client-side API that is configured to interact with the server-side API for requesting and receiving content data of the webpage and the updated user-profile image data. The webpage is a primary page used by the user for social interaction.

In another embodiment, the present invention provides a computer-readable media equipped with programming instructions, which when executed by a computer system directs the computer system to generate contextual user-profile image on a webpage. The computer-readable media comprises instructions for capturing textual content received from a user at the webpage. The computer-readable media further comprises instructions for parsing the textual content to identify keywords related to context; performing contextual analysis of the keywords to identify one or more mood indicators; identify current mood of the user based on the mood indicators, determine modifiers for the user-profile image for the current mood or contextual interest; and update the user-profile image to incorporate the modifiers so as to reflect the current mood or contextual interest. The updated user-profile image is returned to the webpage for rendering, in response to the textual content received from the user.

Other aspects and advantages of the invention will become apparent from the following detailed description, taken in conjunction with the embodiments and accompanying drawings, illustrating, by way of example, the principles of the invention.

### BRIEF DESCRIPTION OF THE DRAWINGS

The invention, together with further advantages thereof, may best be understood by reference to the following description taken in conjunction with the accompanying drawings.

FIG. 1A is an illustration of a system for generating contextual based user-profile image on a webpage, in accordance with an embodiment of the present invention.

FIG. 1B illustrates the various components of the system used in generating and sharing of contextual based user-profile image on one or more webpages, in accordance with an embodiment of the invention.

FIGS. 2.1 through 2.3 provide exemplary user-profile image transitions that are performed dynamically in response to context of the content provided by a user, in accordance with an embodiment of the invention.

FIGS. 3.1 through 3.3 illustrate alternate user-profile image transitions provided by an image generation script at the server, in accordance with an alternate embodiment of the present invention.

FIG. 4 illustrates a process flow operations in generating and sharing of contextual based user-profile image on one or more webpages, in accordance with an embodiment of the invention.

FIG. 5A is a generalized diagram of a typical computer system suitable for use with the present invention.

FIG. 5B shows subsystems in the typical computer system of FIG. 7A.

FIG. 5C is a generalized diagram of a typical network suitable for use with the present invention.

### DETAILED DESCRIPTION

Embodiments of the present invention provide system, methods and computer readable media for generating context related user-profile image for a user on a webpage based on context of content provided by the user. More particularly, according to various embodiments of present invention, an image generating mechanism of the present invention can contextually analyze content provided by a user at the webpage, identify various mood modifiers based on the contextual analysis and dynamically update the user-profile image of the user to incorporate the identified mood modifiers. The resulting user-profile image or “avatar” of the user reflects the current mood, state of mind and/or contextual interest of the user that is reflected in the content presented by the user at the webpage. The image/avatar is returned to the webpage for publishing or rendering. The webpage represents a virtual environment. Such virtual environments can include a webpage, an Internet forum, a virtual community, or any other virtual environment that is used for social interaction by the user. This approach allows user's avatar/user-profile image to be automatically updated without requiring the user to explicitly access and update the image, thereby providing better image personalization.

According to embodiments of the present invention, the user-profile image (or “avatar”) includes multiple parts that can be updated using one or more attributes including, but not limited to, shape and color of the user's facial structure and features, color and shape of the user's facial features, such as eyes/nose/lips/ears/forehead, the user's body type and size (upper and lower), type of clothes worn (upper and lower, including color and style), accessories worn on the different parts of the body (hats, shoes, glasses, gloves, scarves, etc.), occasion or activity specific background (e.g., ski resort during a skiing vacation, high-rise hotel during a business trip, ocean-related theme during a cruise, favorite breed of dog), occasion-specific props (e.g., branded t-shirts specific for an occasion like soccer world cup/super-bowl, etc.), flags, during Presidential election campaign, etc. The above list is exemplary and should not be considered restrictive. Additional attributes related to user-profile image may be captured and updated based on the content provided by the user. The various embodiments, thus, allows for selection of individual items for each of the above type of attributes, from a large collection, and combines them during avatar-creation or avatar-update time, creating the display user-profile image.

The embodiments allow for automatically changing an avatar of a user on a webpage in which they are embedded, such as primary blog pages or webpages, according to the context, content and mood of the user providing input at the webpage. The embodiments also allow for automatic updating of the avatar of the user in various secondary webpages that a user accesses for social interaction by using the updates from the primary blog pages or webpages. Still further, the embodiments allow synchronization of the user-profile image between a primary webpage and a secondary webpage by allowing automatic updating of the avatar/user profile image on both a primary webpage/blog page and a secondary webpage/blog page and updating the user-profile image at either one of the pages to reflect the most current mood or contextual interest of the user. It should be noted herein that for the sake of simplicity, various embodiments are described in detail that are directed toward generation and updating of user-profile image of a user to reflect current mood by identifying and adjusting attributes related to a user, such as facial and other physical features. The current mood, as used in this application, does not only include various mood related attributes defined by facial and physical features of a user-profile image, but may also include attributes that encompass current state of mind, and/or contextual interest of the user. Thus, the current state of mind and/or contextual interest of the user may be expressed by both mood related attributes and non-mood related attributes. The mood related attributes may set a neutral expression in the user-profile image and the non-mood related attributes may be used to set background images, accessories, etc., to reflect the context provided by the user. In the description set forth herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention. The present invention includes several aspects and is presented below and discussed in connection with the Figures and embodiments.

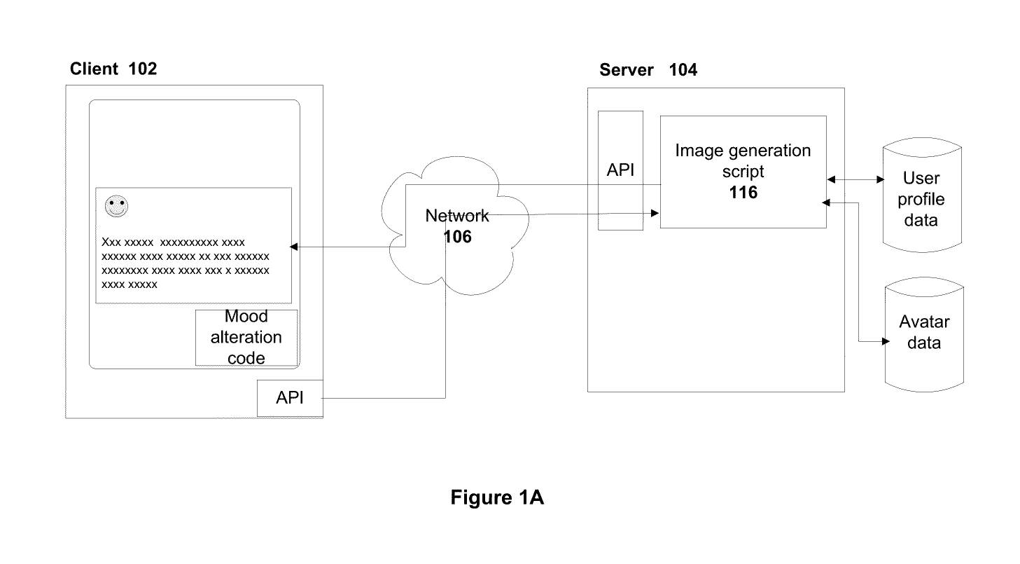

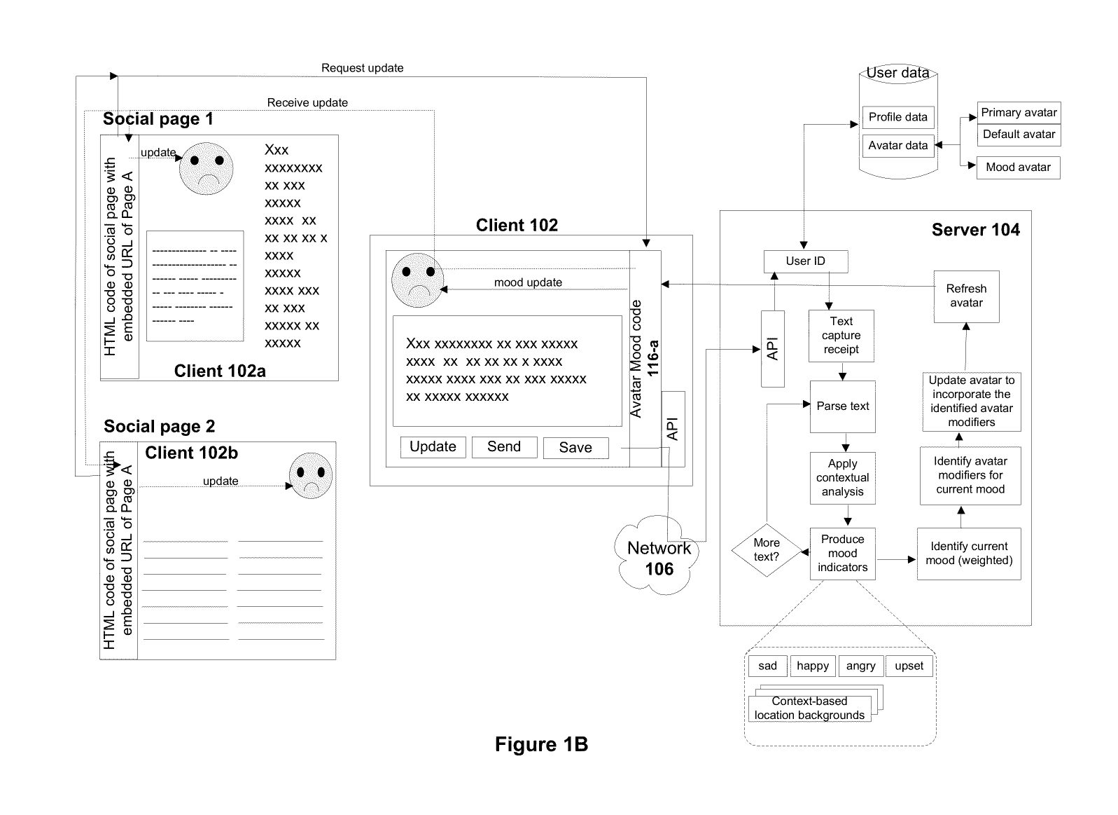

FIG. 1A, according to an embodiment of the present invention, illustrates a system 100 for contextually analyzing content provided by a user on a webpage and generating or updating context related user-profile image of the user for rendering on the webpage. The webpage may be a personal webpage, a weblog page, a social network page or any other webpage available on the Internet that is used for social interaction by the user and on which a user-profile image is or can be embedded. The system 100 includes a client device 102 coupled to the Internet 106, and a processing server (or simply a “server”) 104 coupled to the Internet 106. The client device 102 may be a mobile device, such as a cellular phone, smart phone, or the like, a laptop device, a desktop device, a personal computer, or any other computing device that is capable of being coupled to the Internet 106 and communicate with the server 104. The server 104 is equipped with an image generating mechanism for automatically generating context-related user-profile image for the content provided by the user on the webpage. The image generating mechanism includes a script, such as an image generation script 116 that interacts with the client device 102 through a server-side application programming interface (API) and a corresponding client-side API.

In one embodiment of the present invention, the server 104 is configured to create or update the context avatar of the user 101 by invoking the image generation script 116 in response to a user action at the client device 102. The user action can be an explicit user request for a webpage or entry of textual content on the webpage. The generated/updated context avatar of the user can be a composite image. The composite image can include, among other things, a virtual person image of the user with distinguishing features that can be adjusted to reflect a current mood of the user. In addition, the composite image can also include features related to a background image that is defined/adjusted by the script 116 based on contextual analysis of the content provided by the user at the webpage.

FIG. 1B illustrates the flow of data through the system illustrated in FIG. 1A, during creation/updating of a user-profile image to reflect the current mood of the user. In one embodiment, the user initiates a request for the webpage in order to socially interact with other users. The request for the webpage is transmitted to the server-side script 116 through the client-side and server-side APIs. The requested webpage may be a news content webpage, a personal webpage of the user, or any other webpage that allows the user to socially interact with other users. The requested user may or may not have a defined user-profile image. The script 116 may use user attributes, such as a user identifier (ID), to determine if there is any user-profile image defined for the user. In the case where there is no user-profile images defined for the user, the script 116 includes logic to generate a user-profile image of the user based on user profile data provided by the user. The user-profile data received from the user are stored in a database, such as user-profile database, and used during creation of the webpage and for generating an appropriate user-profile image for the user. In one embodiment, the script 116 may retrieve a default image from a database, such as an image database (not shown), and adjust the various features of the default image to reflect the user attributes defined in the user profile data. The generated user-profile image, in one embodiment, is a composite image that includes a virtual person image data as well as background image. It is important to note that the composite image 108 can include image-based data that represents any subset or combination of information or data related to the user. For instance, the image data can be photographic image data, scanned images, digital artwork (e.g. cartoons, 3D renderings), news information images, or any other image-based data. The image database may be coupled to the server 104 or accessible to the server 104 via the Internet 106. In one embodiment, the user-profile data defines user attributes, such as age, gender, geo-location, interest/hobbies, profession, etc. The generated user-profile image is embedded in the requested webpage and returned to the client device for rendering, in response to the request. In addition to embedding the user-profile image in the webpage, the script also includes client-side script component 116-a in the webpage to monitor user action at the webpage so as to request updates from the script 116 based on the user action.

In the case where the user has a user-profile image defined, the script identifies and includes the user-profile image of the user in the webpage returned to the client. In the case where there is more than one user-profile images defined for the user, the script 116 selects the user-profile image that is currently active or the primary image to include in the webpage returned to the client, in response to the request. The webpage returned to the client is rendered, wherein the user is allowed to socially interact with other users.

Upon the rendering of the webpage, the user may provide comments related to content at the webpage. The comments may be in the form of textual content, such as a weblog (i.e. blog) in response to an article published on the webpage, a blog post in response to a comment posted by another user on the article published on the webpage, or blog post initiated by the user. The client-side script component 116-a at the webpage includes logic to detect the input from the user and generate an event trigger. The event trigger could be initiated automatically based on user action at the webpage. The client-side script 116-a defines the various event triggers that can be initiated based on user action at the webpage. For instance, the event trigger could be initiated by an event, such as a page load event, a page save event, a page update event, etc., based on the related user action at the webpage. The above list of events should be considered exemplary and should not be considered restrictive. The event trigger could also be initiated automatically based on a variable that is programmable. For instance, the variable could be a time-based variable that could be automatically initiated after lapse of certain period of time, such as after every minute, after every 5 minutes, etc, or after a certain period of inaction at the webpage or may be content based variable, such as presence of a delimiter in the textual content provided by the user, upon occurrence of number of delimiters in the textual content, etc. In one embodiment, the automatic event trigger may be initiated dynamically during run-time as the user continues to enter textual content on the webpage.

In response to the event trigger, the script component 116-a generates a submit request and transmits the request to the server. The client-side component 116-a communicates the submit request to the server-side script 116. The submit request is routed to the script 116 through the client-side API and the server-side API. In one embodiment, the request is communicated to the server using AJAX communication. Asynchronous JavaScript and XML (AJAX) communication is a communication technique that is used by a browser on a client device to request and receive information from a server asynchronously without interfering with the rendering and behavior of the webpage.

The server 104 receives the submit request and the trigger event, and in response, invokes the script 116 to generate or update the user-profile image. The script 116 receives the request, and in response, downloads the textual content provided by the user at the webpage. The script then parses the downloaded textual content to identify keywords. In one embodiment, the script 116 may use search algorithm or an algorithm similar to the search algorithm to analyze the textual content and identify the token keywords. Other algorithms may be used so long as the algorithm is capable of analyzing the textual content and identifying the keywords. The script then performs contextual analysis of the keywords to identify certain mood and context indicators. In one embodiment, the mood indicators describe one or more facial or bodily expressions defining a mood or activity related to the user. For instance, the mood indicator may include expressions, such as sad, happy, angry, frustrated, etc. The aforementioned list of expressions is exemplary and should not be considered restrictive. In one embodiment, the context indicators may describe a background to define a mood or activity associated with the user based on the contextual analysis of the content. For instance, the context indicator may define a background of the user based on location indicated in the content, such as an exotic vacation spot, location based on a business trip, etc., or interest of the user as provided in the content, such as pet related background, biking, other hobby related background, etc.

In one embodiment, the script may rely on a mapping table to identify the appropriate mood and context indicators that relate to specific keywords. The mapping table is generated by first extracting keywords from description of user-profile image sub-components. In one embodiment, a default user-profile image may be used for defining keywords that describe user-profile image sub-components. The mapping table is indexed by the keywords and stored in a database for subsequent matching by the script 116. The script 116 uses the keywords identified from the analysis of the textual content provided by the user at the webpage and finds matches with the corresponding keywords in the mapping table to identify the corresponding mood indicators. In one embodiment, when more than one mood indicator matches a particular keyword, the script 116 includes an algorithm to score each of the mood indicators. The scoring may be based on type of the mood indicator and the user interaction at each of the identified mood indicators over time. Scoring based on user interactions related to the respective mood indicators for a particular keyword is indicative of a strength of the relationship of the respective mood indicators to the particular keyword, such that the mood indicator with the highest score defining a greater match to the keyword. As a result, the script 116 selects the mood indicators with the highest scores as a match to the keywords. The context indicators are similarly selected by the script 116. It should be noted herein that although the various embodiments are directed toward identifying only mood indicators to define a current mood, the embodiments can be easily extended to identify context indicators to define a state of mind of the user.

The script 116 then identifies the current mood or state of mind of the user using the mood and context indicators. The mood and context indicators may identify more than one mood. When the identified mood indicators identify different moods, the script 116 may rely on a ranking algorithm to identify the mood indicators that define the current mood. For instance, based on the contextual analysis of the keywords, the script 116 may identify a sad mood and a happy mood for the user. The various moods identified by the script are exemplary and should not be considered restrictive. In order to define the current mood, the script 116, in one embodiment, weighs the mood indicators related to one mood against the mood indicators related to the other mood using a ranking algorithm and the current mood is identified based on the relative ranking of the respective mood indicators. The ranking algorithm is provided within the script 116 or is available to the script at the server 104. The ranking algorithm, in one embodiment, may include logic to rank the respective mood indicators for each of the moods based on the order in which they appear in the textual content provided by the user at the client device. For instance, the ranking algorithm may provide more weight to the mood indicators associated with last sentence in the textual content provided by the user and provide less weight to the mood indicators associated with earlier sentences of the textual content. Based on the relative ranking, the script 116 identifies the related mood indicators to reflect a current mood of the user. The aforementioned weighted ranking is one way of identifying the appropriate mood indicators for defining a current mood of the user. Other ranking algorithms may be used to identify the mood indicators to reflect the current mood of the user.

Once the current mood of the user is identified, the script 116 then determines the mood modifiers that relate to the current mood. The mood modifiers are identified based on the mood indicators related to the current mood. The mood modifiers, for instance, may include items or features relating to the mood indicators that can be adjusted in the image to define the current mood of the user, such as accessories (hats, sunglasses, beachwear, dress, etc.), facial features (shape/color of ear, nose, chin, forehead, mouth, etc), background images, etc. The mood modifiers identified by the script 116 are then incorporated into the user-profile image of the user to reflect the current mood of the user. The updated user-profile image is packaged with the webpage and transmitted to the client-device for rendering, in response to the trigger event initiated at the client-device. The updated user-profile is also stored in a database for subsequent rendering at the webpage or for sharing with other webpages.

In one embodiment, the updated user-profile image from the webpage can be shared with other webpages that the user would use to socially interact with other users. When the user starts a secondary webpage for social interaction, the secondary webpage may or may not accommodate rendering of the user-profile image of the user. If the secondary webpage accommodates the rendering of the user-profile image, then the HTML code defining the secondary webpage is updated to embed an URL of the initial webpage that includes the updated user-profile image, which acts as a primary webpage. When a user selects the secondary webpage for social interaction, the API at the client device detects the webpage selection and retrieves the secondary webpage for loading at the client-device. During the loading of the secondary webpage, the API identifies the embedded URL and sends a request to the client-side script component 116-a at the primary webpage to provide the updated user-profile image. The client-side script 116-a receives the request and in response to the request, the client-side script 116-a retrieves the updated user-profile image and forwards the same to the secondary webpage for rendering. The HTML code may include additional logic to trigger a request to obtain the updated user-profile image from the primary webpage periodically.

In yet another embodiment, the primary webpage and the secondary webpage may both include user-profile image of the user. The user-profile image at the respective webpages is updated as and when the user uses the respective webpages for social interaction. The update reflects the current mood of the user based on the contextual analysis of the content provided by the user at the respective webpages. In addition, the primary webpage and the secondary webpage have the ability to synchronize the user-profile image as and when the user-profile image is updated at any one of the primary and the secondary webpages. For instance, the user-profile image of the primary webpage may be accessed first and the user may have provided textual content, such as blog, comment, etc. Based on the contextual analysis of the textual content, the user-profile image of the primary webpage may have been updated to reflect the user's current mood. Along with updating the user-profile image at the primary webpage, the image of the user at the secondary webpage may also be simultaneously updated to reflect the current mood. Subsequently, when the user accesses the secondary webpage, the user-profile image at the secondary webpage reflects the current mood of the user as presented in the primary webpage. Upon accessing the secondary webpage, the user may post a textual content, such as comment, at the secondary webpage. In response to the textual context, the user-profile image at the secondary webpage may be updated to reflect the user's current mood by contextually analyzing the content provided at the secondary webpage. The mood reflected at the secondary webpage may be different from the mood reflected in the primary webpage or include additional attributes. As a result, the image at the primary webpage may be automatically updated from the secondary webpage so that both the primary and the secondary webpages are synchronized and reflect the user's current mood. In order to achieve this, the HTML code at the respective primary and secondary webpages is modified to include the URL of one another. In addition to the URL, the primary and the secondary pages include client-side script component 116-a at the respective webpages. The API at the client-device interacts with the script components 116-a at the respective webpages and with the server-side script 116 to request the updated user-profile image either from the server or from one another. In one embodiment, in response to the request or a trigger event, either the server-side script 116 forwards the updated user-profile image to the client-side script directly for rendering at the respective webpages or the primary/secondary webpages exchange the updated user-profile image with one another.

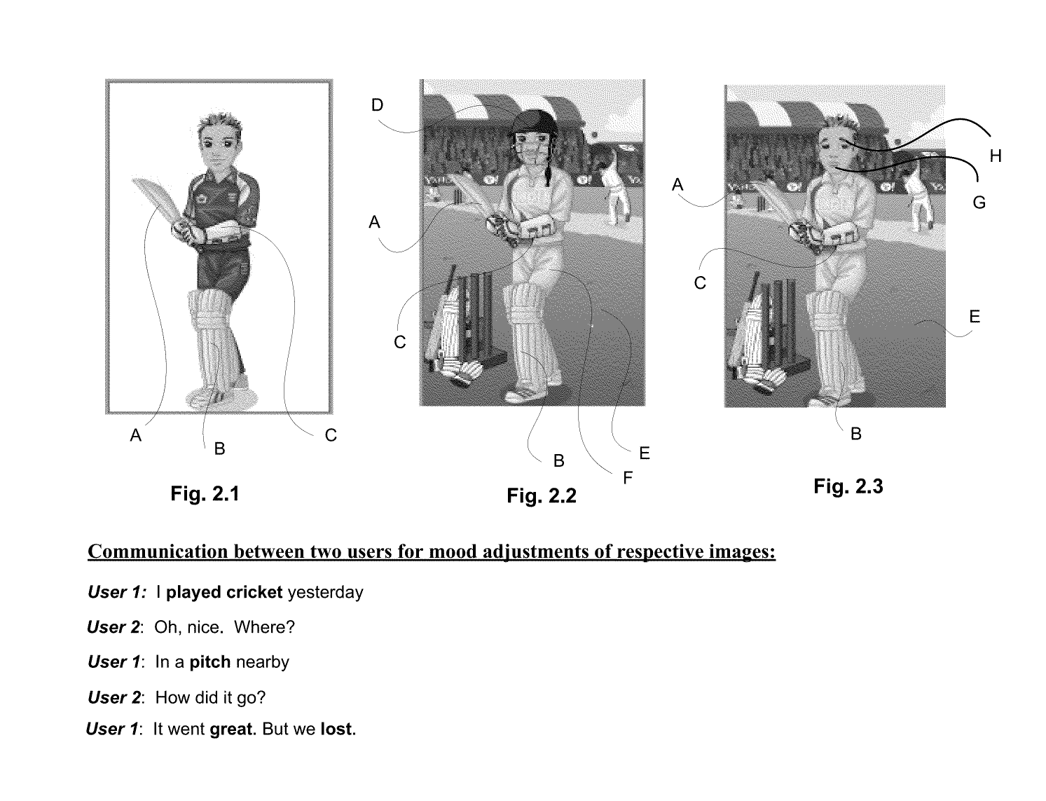

FIGS. 2.1 to 2.3 illustrate the composite user-profile image generated/updated by the server-side script 116 based on the content provided by the user, in one embodiment of the invention. In this embodiment, the updates to the user-profile image are done on-the-fly as the user continues to communicate with other users. As a result, the composite user-profile image may change depending on the mood or the state of mind of the user. As illustrated in FIG. 2.1, the user-profile image of User 1 is updated to reflect the mood based on the analysis of the keywords. The script 116 analyzes and identifies the keywords “played” and “cricket” and these keywords are used to identify the mood modifiers. As a result, the user-profile image is updated to include a cricket bat 2.1A, leg guards 2.1B, and hand guards/gloves 2.1C. Based on continued input from the user, the script 116 identifies keywords “pitch” from a subsequent interaction and dynamically updates user-profile image of user 1 to further include a background image of a cricket pitch 2.2E. Additionally, the script 116 may equate the pitch to a tournament being played, and update the dress of the user-profile image to include a uniform 2.2F and a helmet 2.2D. Based on user 1's continued interaction, the script 116 determines the current mood of the user and updates the one or more attributes of the user-profile image. Thus, script 116 recognizes the keywords “great” and “lost” from the third interaction of the user and determines that the keywords define two different moods, a happy mood for keyword “great” and a sad mood for the keyword “lost”. The script 116 weighs the two keywords to define the relative ranking of the two keywords in order to determine the current mood. In the example illustrated in FIG. 2.3, the keyword “lost” outweighs the keyword “great” based on a ranking algorithm used by the script 116 that weight the order of appearance of the two keywords. As a result, the expression on the user-profile image is adjusted to depict a sad face, as illustrated by 2.3G (downturned mouth) and 2.3H (downturned eyes). In this embodiment, the script 116 uses delimiters within the textual content provided by the user to perform periodic analysis by identifying keywords in the content and to update the user-profile image to reflect the current mood of the user.

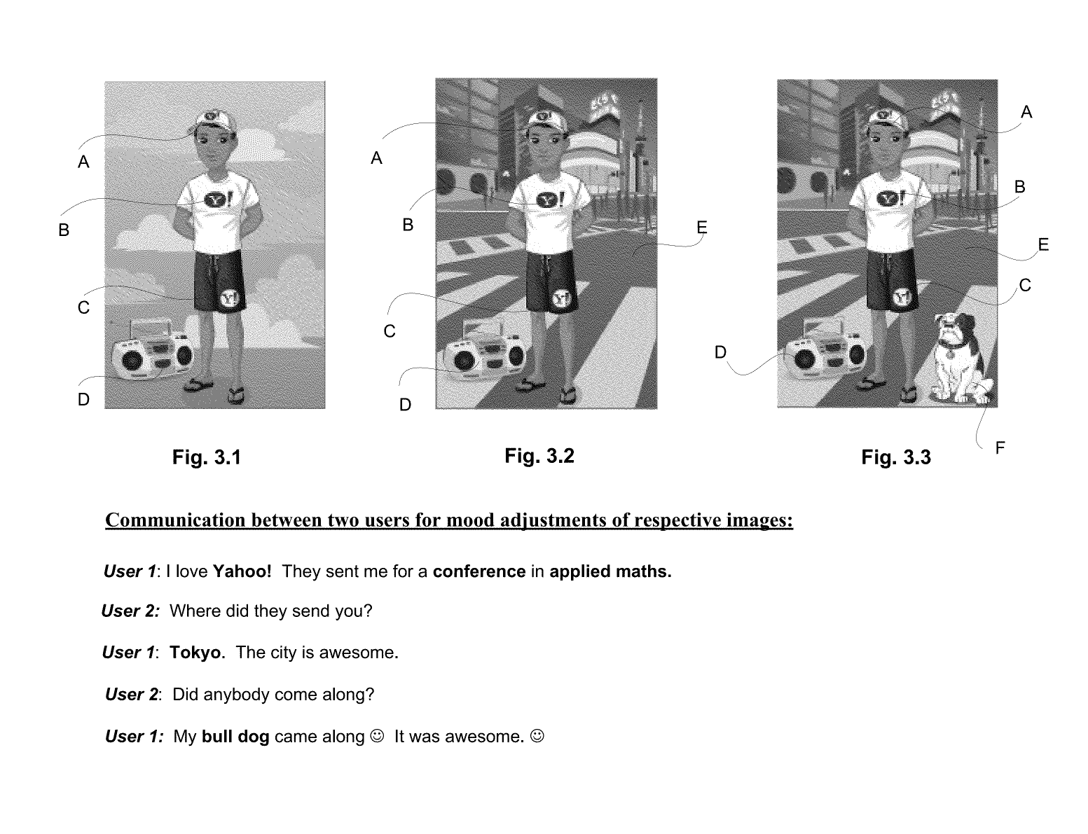

FIGS. 3.1-3.3 illustrate the composite user-profile image generated/updated by the script 116 based on user content provided at a webpage. As illustrated in FIG. 3.1, the script 116 identifies keywords “Yahoo!”, “conference” and “applied math” from the content of the first user interaction of User 1 at a primary webpage. The script then tries to identify the mood modifiers for the keywords. The script 116 is able to identify mood modifiers for keyword “Yahoo!” but cannot find a match for keywords “conference” and “applied math”. As a result, the script ignores the keywords for which no match is found and updates the user-profile image with modifiers from the matched keyword so as to include the accessories, cap 3.1A, t-shirt 3.1B, shorts 3.1C, and a radio/tape-deck 3.1D. The script continues to track the interaction of User 1 at the webpage. Based on the second interaction, the script 116 identifies keyword “Tokyo” and updates the background attribute of the user-profile image to a scene from Tokyo, as illustrated by 3.2E. In one embodiment, the script 116 may identify more than one scene from Tokyo. In this embodiment, the script logic picks the most favorite and frequently used scene to update the user-profile image. Based on the third interaction, the script 116 identifies the type of dog associated with User 1 as defined by the keywords in the interaction, and updates the user-profile image to include an image of a bull dog while continuing to keep the previous updates to the user-profile image in place.

Thus, the various embodiments of the invention provide a way to contextually analyze textual content provided by a user and generate appropriate user-profile image to reflect the current mood of the user. The generated user-profile image can be updated to other webpages and such updates to the webpages can be carried out automatically without any user interaction. Further, these updates can be carried out dynamically in substantial real-time making this a more efficient way of personalizing a user's profile image.

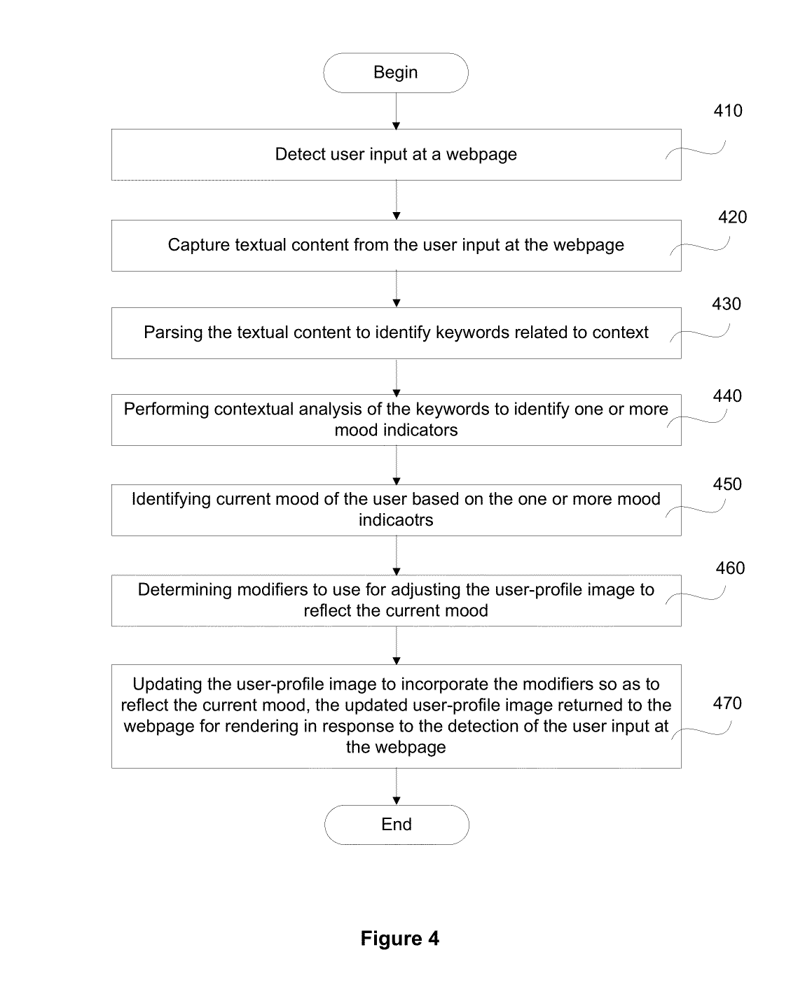

In FIG. 4, is an illustration of a method for providing context related user-profile image of a user on a webpage, according to one embodiment of the present invention. The method begins at operation 410 where an image generation script 116 of the processing server 104 detects user input at a webpage rendered at a client-device. The script 116 captures the textual content from the user input at the webpage, as illustrated in operation 420. The capturing of the textual content may be in response to a user action or based on a trigger event that is defined for the webpage. The webpage includes a client-side script component that specifies the various trigger events that initiates a submit request based on user action at the webpage. The script parses the textual content to identify keywords in the user input, as illustrated in operation 430. The script can use a search algorithm or an algorithm that is similar to a search algorithm to identify various keyword tokens. Upon identification of the keywords, the script 116 can perform contextual analysis of the keywords to identify one or more mood indicators, as illustrated in operation 440. The contextual analysis analyzes a group of words to determine the context and identify one or more mood indicators that best describe the context.

The mood indicators are sorted, scored and analyzed to determine a current mood of the user, as illustrated in operation 450. When more than one mood indicator is identified for a particular keyword, the script may score the mood indicators based on user interaction at each of the mood indicators and the type of user interaction to determine the most popular mood indicators for a particular keyword. Using the mood indicators that define the current mood, the script identifies the various modifiers that need to be incorporated into the user-profile image to reflect the current mood of the user, as illustrated in operation 460. The modifiers are incorporated into the user-profile image for the user so that the user-profile image reflects the current mood of the user, as illustrated in operation 470.

When there is no user-profile image defined for the user, the script identifies a default image based on the user-profile data provided by the user and updates the default image with the modifiers to reflect the user's current mood. The updated user-profile image is returned to the webpage at the client device for rendering. The updated user-profile image can be shared among other webpages that are used by the user for social interaction. In one embodiment, a user may have a defined user-profile image and this user-profile image may be used in one or more webpages during social interaction. In one embodiment, the user may access his user-profile image by logging into a related site that provides access and allows modification of the user-profile image. Upon accessing the user-profile image, the user may provide textual content, such as “I went to Tokyo for a conference,” or “I played baseball yesterday.” The script analyzes the textual content and updates the relevant attributes of the user-profile image to reflect the contextual interest or current mood of the user. In this embodiment, the user's current mood may be expressed with a neutral expression. Upon update, the user may save the updated user-profile image as the default avatar that is shared among other websites where the user-profile image is rendered.

The current embodiments provide an efficient tool to generate user-profile images (avatars) that automatically change according to the context, content, interest and mood of the content provided in the webpage in which the images are embedded or defined in a designated user-profile page. The script identifies a user's mood or state of mind as expressed in their blog and updates the user's profile image, if one is available, or generates a user-profile image according to the blog, leading to better personalization. To manage the context efficiently, the script builds an indexed mapping of keywords extracted from description of avatar sub-components/items to the sub-components graphics. The mapping may be done offline and updated periodically. The personalized user-profile image generated automatically reflects the current state of mind of the user.

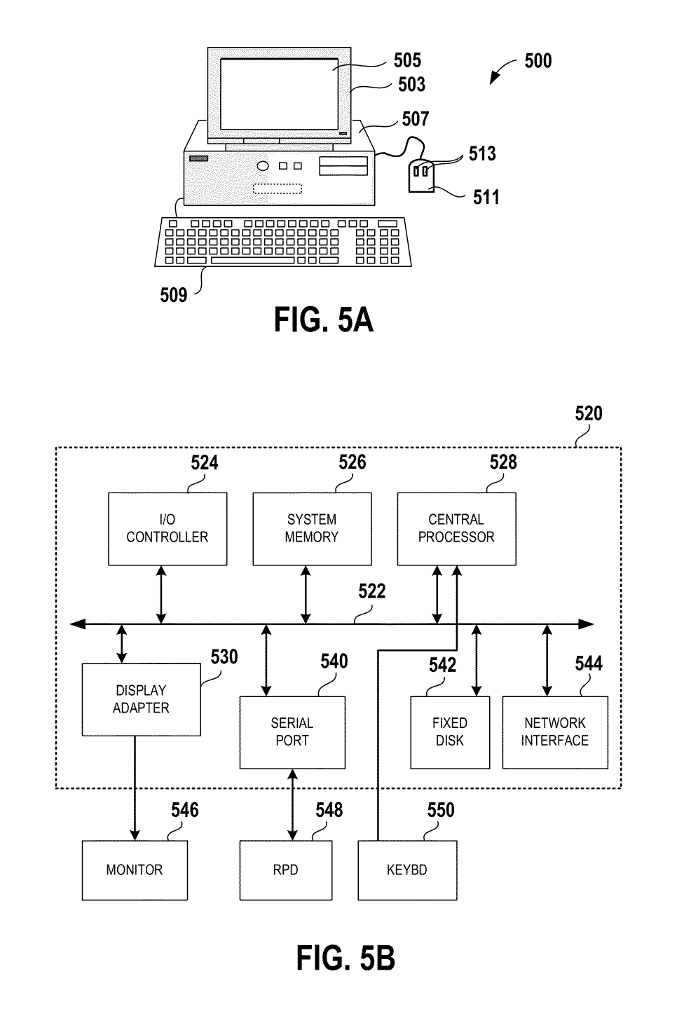

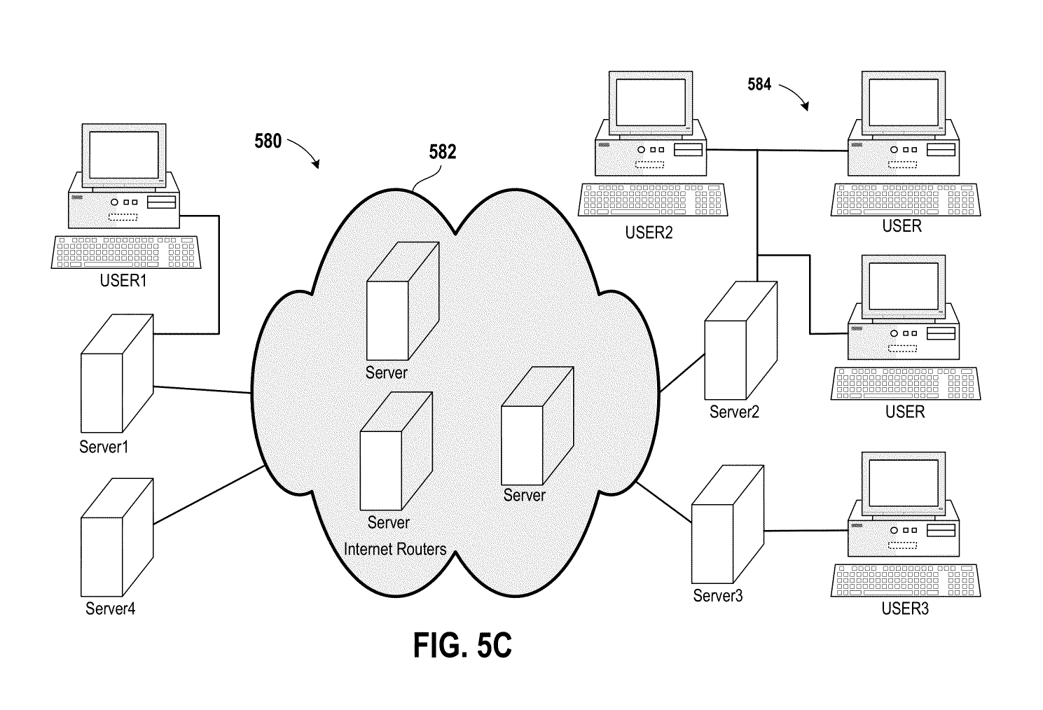

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network. A sample computer system is depicted in FIGS. 5A-5C.

In FIG. 5A, is an illustration of an embodiment of an exemplary computer system 500 suitable for use with the present invention including display 503 having display screen 505. Cabinet 507 houses standard computer components (not shown) such as a disk drive, CDROM drive, display adapter, network card, random access memory (RAM), central processing unit (CPU), and other components, subsystems and devices. User input devices such as a mouse 511 having buttons 513, and keyboard 509 are shown. Other user input devices such as a trackball, touch-screen, digitizing tablet, etc. can be used. In general, the computer system is illustrative of but one type of computer system, such as a desktop computer, suitable for use with the present invention. Computers can be configured with many different hardware components and can be made in many dimensions and styles (e.g. laptop, palmtop, pentop, server, workstation, mainframe). Any hardware platform suitable for performing the processing described herein is suitable for use with the present invention.

FIG. 5B illustrates subsystems that might typically be found in a computer such as computer 500. In FIG. 5B, subsystems within box 520 are directly interfaced to internal bus 522. Such subsystems typically are contained within the computer system such as within cabinet 507 of FIG. 5A. Subsystems include input/output (I/O) controller 524, System Random Access Memory (RAM) 526, Central Processing Unit (CPU) 528, Display Adapter 530, Serial Port 540, Fixed Disk 542 and Network Interface Adapter 544. The use of bus 522 allows each of the subsystems to transfer data among the subsystems and, most importantly, with the CPU. External devices can communicate with the CPU or other subsystems via the bus 522 by interfacing with a subsystem on the bus. Monitor 546 connects to the bus through Display Adapter 530. A relative pointing device (RPD) 548 such as a mouse connects through Serial Port 540. Some devices such as a Keyboard 550 can communicate with the CPU by direct means without using the main data bus as, for example, via an interrupt controller and associated registers (not shown).

As with the external physical configuration shown in FIG. 5A, many subsystem configurations are possible. FIG. 5B is illustrative of but one suitable configuration. Subsystems, components or devices other than those shown in FIG. 5B can be added. A suitable computer system can be achieved without using all of the subsystems shown in FIG. 5B. For example, a standalone computer need not be coupled to a network so Network Interface 544 would not be required. Other subsystems such as a CDROM drive, graphics accelerator, etc. can be included in the configuration without affecting the performance of the system of the present invention.

FIG. 5C is a generalized diagram of a typical network. In FIG. 5C, the network system 580 includes several local networks coupled to the Internet. Although specific network protocols, physical layers, topologies, and other network properties are presented herein, embodiments of the present invention are suitable for use with any network.

In FIG. 5C, computer USER1 is connected to Server1. This connection can be by a network such as Ethernet, Asynchronous Transfer Mode, IEEE standard 1553 bus, modem connection, Universal Serial Bus, etc. The communication link need not be wire but can be infrared, radio wave transmission, etc. Server1 is coupled to the Internet. The Internet is shown symbolically as a collection of server routers 582. Note that the use of the Internet for distribution or communication of information is not strictly necessary to practice the present invention but is merely used to illustrate embodiments, above. Further, the use of server computers and the designation of server and client machines are not critical to an implementation of the present invention. USER1 Computer can be connected directly to the Internet. Server1's connection to the Internet is typically by a relatively high bandwidth transmission medium such as a T1 or T3 line.

Similarly, other computers at 584 are shown utilizing a local network at a different location from USER1 computer. The computers at 584 are couple to the Internet via Server2. USER3 and Server3 represent yet a third installation.

Note that the concepts of “client” and “server,” as used in this application and the industry are very loosely defined and, in fact, are not fixed with respect to machines or software processes executing on the machines. Typically, a server is a machine or process that is providing information to another machine or process, i.e., the “client,” that requests the information. In this respect, a computer or process can be acting as a client at one point in time (because it is requesting information). Some computers are consistently referred to as “servers” because they usually act as a repository for a large amount of information that is often requested. For example, a World Wide Web (WWW, or simply, “Web”) site is often hosted by a server computer with a large storage capacity, high-speed processor and Internet link having the ability to handle many high-bandwidth communication lines.

A server machine will most likely not be manually operated by a human user on a continual basis, but, instead, has software for constantly, and automatically, responding to information requests. On the other hand, some machines, such as desktop computers, are typically thought of as client machines because they are primarily used to obtain information from the Internet for a user operating the machine. Depending on the specific software executing at any point in time on these machines, the machine may actually be performing the role of a client or server, as the need may be. For example, a user's desktop computer can provide information to another desktop computer. Or a server may directly communicate with another server computer. Sometimes this is characterized as “peer-to-peer,” communication. Although processes of the present invention, and the hardware executing the processes, may be characterized by language common to a discussion of the Internet (e.g., “client,” “server,” “peer”) it should be apparent that software of the present invention can execute on any type of suitable hardware including networks other than the Internet.

Although software of the present invention may be presented as a single entity, such software is readily able to be executed on multiple machines. That is, there may be multiple instances of a given software program, a single program may be executing on different physical machines, etc. Further, two different programs, such as a client a server program, can be executing in a single machine, or in different machines. A single program can be operating as a client for information transaction and as a server for a different information transaction.

A “computer” for purposes of embodiments of the present invention may include any processor-containing device, such as a mainframe computer, personal computer, laptop, notebook, microcomputer, server, personal data manager or personal information manager (also referred to as a “PIM”) smart cellular or other phone, so-called smart card, set-top box, or any of the like. A “computer program” may include any suitable locally or remotely executable program or sequence of coded instructions which are to be inserted into a computer, well known to those skilled in the art. Stated more specifically, a computer program includes an organized list of instructions that, when executed, causes the computer to behave in a predetermined manner. A computer program contains a list of ingredients (called variables) and a list of directions (called statements) that tell the computer what to do with the variables. The variables may represent numeric data, text, audio or graphical images. If a computer is employed for synchronously presenting multiple video program ID streams, such as on a display screen of the computer, the computer would have suitable instructions (e.g., source code) for allowing a user to synchronously display multiple video program ID streams in accordance with the embodiments of the present invention. Similarly, if a computer is employed for presenting other media via a suitable directly or indirectly coupled input/output (I/O) device, the computer would have suitable instructions for allowing a user to input or output (e.g., present) program code and/or data information respectively in accordance with the embodiments of the present invention.

A “computer-readable medium” or “computer-readable media” for purposes of embodiments of the present invention may be any medium/media that can contain, store, communicate, propagate, or transport the computer program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, carrier wave, or computer memory. The computer readable medium may have suitable instructions for synchronously presenting multiple video program ID streams, such as on a display screen, or for providing for input or presenting in accordance with various embodiments of the present invention.

With the above embodiments in mind, it should be understood that the invention could employ various computer-implemented operations involving data stored in computer systems. These operations can include the physical transformations of data, saving of data, and display of data. These operations are those requiring physical manipulation of physical quantities. Usually, though not necessarily, these quantities take the form of electrical or magnetic signals capable of being stored, transferred, combined, compared and otherwise manipulated. Data can also be stored in the network during capture and transmission over a network. The storage can be, for example, at network nodes and memory associated with a server, and other computing devices, including portable devices.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can thereafter be read by a computer system. The computer readable medium can also be distributed over a network-coupled computer system so that the computer readable code is stored and executed in a distributed fashion.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for generating contextual user-profile image on a webpage, comprising:
capturing textual content received from a user at the webpage;
parsing the textual content to identify keywords related to context;
performing contextual analysis of the keywords to identify one or more mood indicators;
identifying current mood of the user based on the one or more mood indicators;
determining modifiers for the user-profile image for the current mood; and
updating the user-profile image to incorporate the modifiers so as to reflect the current mood, wherein the updated user-profile image is returned to the webpage for rendering, in response to the textual content received from the user.

2. The method of claim 1, wherein parsing is performed in response to a trigger event at the webpage.

3. The method of claim 1, wherein the trigger event is any one of page load, update, page save.

4. The method of claim 1, wherein parsing is performed based on a variable, wherein the variable is programmable.

5. The method of claim 1, wherein identifying one or more mood indicators further includes,
generating a mapping of keywords extracted from description of user-profile image sub-components to mood indicators, wherein each mood indicator identifies a modifier for modifying a specific graphic feature of the user-profile image; and
matching the keywords identified from textual content at the webpage to specific one or more mood indicators using the mapping, the matching identifying the specific graphic features that has to be modified in the user-profile image to reflect the current mood.

6. The method of claim 1, wherein when a particular keyword matches with a plurality of mood indicators,
scoring each of the plurality of mood indicators that match the particular keyword, the scoring based on type of the mood indicator and user interaction received for the respective mood indicator over time, wherein the user interaction defines relative popularity of the respective mood indicator; and
selecting the mood indicator with a highest score for modifying the user-profile image.

7. The method of claim 1, wherein identifying current mood further includes,
when the one or more mood indicators identify different moods,
ranking the one or more mood indicators based on a ranking algorithm to generate a ranking score for each of the mood indicators, the ranking score reflecting relative ranking of each of the mood indicators;
identifying the current mood from the one or more mood indicators based on the relative ranking of the mood indicators.

8. The method of 1, further includes,
synchronizing the user-profile image updated in the webpage with a secondary webpage, wherein the secondary webpage includes the user-profile image.

9. A method for generating contextual user-profile image on a webpage, comprising:
obtaining user identifier of a user accessing the webpage for social interaction, wherein the social interaction includes textual content provided by the user;
determining if the user-profile image exists for the user associated with the user identifier;
if the user-profile image does not exist for the user,
determining user profile data of the user, the user profile data defining user attributes provided by the user;
generating a user-profile image for the user from a default image using the user attributes defined in the user profile data; and
dynamically modifying the user-profile image of the user to reflect a current mood of the user based on the textual content received from the user at the webpage, wherein the modifying is performed based on analysis of the textual content received from the user, the analysis defining the current mood of the user, the modified user-profile image returned to the webpage for rendering, in response to the textual content received from the user.

10. The method of claim 9, wherein modifying further includes,
downloading the textual content received from the user at the webpage;
parsing the textual content to identify keywords related to context;
performing contextual analysis of the keywords to identify one or more mood indicators;
determining current mood of the user based on the one or more mood indicators;
identifying modifiers for the user-profile image for the current mood; and
updating the user-profile image for the user to incorporate the identified modifiers so as to reflect the current mood of the user, wherein the updated user-profile image is returned to the webpage for rendering, in response to the textual content received from the user.

11. The method of claim 9, wherein capturing of the textual content is based on a trigger event at the webpage, the trigger event defined based on type of the webpage.

12. The method of claim 11, wherein the trigger event is one from a group consisting of page load, page update, page save, presence of content delimiter, hard break, timed event.

13. A system for generating context related user-profile image on a webpage, comprising:
a server coupled to the Internet, the server equipped with a image generation script for generating the context related user-profile image on the webpage, the image generation script configured to,
receive a request for an updated user-profile image of a user from the webpage, the request received in response to textual content provided at the webpage, the request including one or more user parameters;
generate the updated user-profile image for the user based on the textual content provided by the user at the webpage, wherein the generating includes,
extracting the textual content provided by the user from the webpage;
extracting keywords from the extracted textual content;
identifying one or more mood indicators by performing contextual analysis of the extracted keywords;
determining current mood of the user based on the one or more mood indicators;
identifying mood modifiers for applying to the user-profile image for the current mood;
updating the user-profile image of the user by applying the identified mood modifiers to the user-profile image, the updated user-profile image reflecting the current mood of the user; and
a client device coupled to the Internet, the client device used in requesting and rendering of the webpage with a user-profile image, wherein the webpage includes a client-side code that is configured to interact with the image generation script on the server for submitting requests for an updated user-profile image and textual content and for receiving the updated user-profile image,
wherein the webpage is a primary page used by the user for social interaction.

14. The system of claim 13, further includes a repository for storing the user-profile image, user profile data, user parameters, page parameters, mapping of the keywords to the mood indicators,
wherein the user profile image stored in the repository is used for subsequent rendering at the webpage or for sharing with a secondary webpage in response to user interaction at the webpage or the secondary webpage.

15. A non-transitory computer readable medium including program instructions for executing on a computing system to generate context related user-profile image on a webpage, comprising:
program instructions for capturing textual content received from a user at the webpage;
program instructions for parsing the textual content to identify keywords related to context;
program instructions for performing contextual analysis of the keywords to identify one or more mood indicators;
program instructions for identifying current mood of the user based on the one or more mood indicators;
program instructions for determining modifiers for the user-profile image for the current mood; and
program instructions for updating the user-profile image (avatar) to incorporate the modifiers so as to reflect the current mood, wherein the updated user-profile image is returned to the webpage for rendering, in response to the textual content received from the user.

16. The computer readable medium of claim 15, wherein the user parameters includes one or combination of user identifier, one or more user attributes defining user profile data, textual content provided at the primary page, trigger event and one or more page attributes.

17. The computer readable medium of claim 15, wherein the request is made in response to a trigger event at the webpage.

18. The computer readable medium of claim 13, further includes,
program instructions for receiving the user identifier of the user accessing the webpage;
program instructions for determining if a user profile image exists for the user associated with the user identifier;
if the user-profile image does not exist for the user,
program instructions for extracting the user profile data of the user, the user profile data identifying user attributes provided by the user;
program instructions for generating the user-profile image for the user from a default image based on the user profile data of the user, the user-profile image of the user updated by applying the identified modifiers to reflect the current mood of the user.

19. The computer readable medium of claim 15, further includes,
program instructions for identifying a secondary page used by the user for social interaction;
program instructions for determining if the user-profile image of the user is to be included in the secondary page;
when the user-profile image is to be included in the secondary page,
program instructions for providing a link to the webpage as a uniform resource locator (URL) at the secondary page; and
program instructions for defining a trigger event for initiating a request to the webpage, the request from the secondary page configured to interact with the client-side code of the webpage to retrieve the updated user-profile image from the webpage for rendering at the secondary page.

20. The computer readable medium of claim 19, wherein the link is provided as a HTML tag and wherein the request uses AJAX communication to request and receive the updated user-profile image from the webpage in substantial real-time.
